(19) United States
(12) Patent Application Publication
(10) Pub. No.: US 2025/0219698 A1
(43) Pub. Date: Jul. 3, 2025

(54) CSI PROCESSING MODE SWITCHING METHOD AND APPARATUS, AND MEDIUM, PRODUCT AND CHIP

(71) Applicant: Beijing Xiaomi Mobile Software Co., Ltd., Beijing (CN)

(72) Inventors: Qin MU, Beijing (CN); Qun ZHAO, Beijing (CN)

(73) Assignee: Beijing Xiaomi Mobile Software Co., Ltd., Beijing (CN)

(21) Appl. No.: 18/852,237

(22) PCT Filed: Mar. 31, 2022
(86) PCT No.: PCT/CN2022/084639

§ 371 Date: Sep. 27, 2024

(51) Int. Cl. H04B 7/06; H04B 17/391; H04W 8/22; H04W 72/231

(52) U.S. Cl. CPC H04B 7/0626; H04B 17/3913; H04W 8/22; H04W 72/231

(57) ABSTRACT

A method for switching channel status indicator (CSI) processing mode includes: receiving a switching instruction sent by a network device; and switching, based on the switching instruction, from a first CSI processing mode to a second CSI processing mode.

### CROSS REFERENCE TO RELATED APPLICATION

This application is a National Stage of International Application No. PCT/CN2022/084639, filed on Mar. 31, 2022, which is incorporated by reference herein in its entireties for all purposes.

### TECHNICAL FIELD

This disclosure relates to the field of communications, and in particular to a method, an apparatus, a medium, a product and a chip for switching a CSI processing mode.

### BACKGROUND

In the 5G NR (New Radio) system, the number of information flows that a channel can carry, channel quality or signal-to-noise ratio, channel matrix, and the like can be obtained through the CSI (Channel Status Indicator). Therefore, the acquisition and feedback of CSI is very important.

As to feedback of CSI, the 3GPP (3rd Generation Partner Project) has standardized a Type I codebook and a Type II codebook. AI (Artificial Intelligence) technology is further introduced to realize CSI feedback with any feedback bits and any accuracy requirements through the AI network.

In related art, after determining that a terminal has AI-based CSI processing capabilities, the network will default to the terminal always performing CSI feedback based on AI.

### SUMMARY

Some embodiments of this disclosure provide a method, an apparatus, a medium, a product and a chip for switching a CSI processing mode. The technical solutions are as follows.

According to an aspect of embodiments of this disclosure, a method for switching a CSI processing mode is provided. The method is performed by a terminal and includes:
receiving a switching instruction sent by a network device; and
switching, based on the switching instruction, from a first CSI processing mode to a second CSI processing mode.

According to another aspect of embodiments of this disclosure, a method for switching a CSI processing mode is provided. The method is performed by a terminal and includes:
switching from a first CSI processing mode to a second CSI processing mode; and
sending a notification instruction to a network device, where the notification instruction is used to indicate the network device to process CSI feedback information of the terminal based on the second CSI processing mode.

According to another aspect of embodiments of this disclosure, a method for switching a CSI processing mode is provided. The method is performed by a terminal and includes:
sending a switching instruction to a terminal, where the switching instruction is used to indicate the terminal to switch from a first CSI processing mode to a second CSI processing mode.

According to another aspect of embodiments of this disclosure, a terminal is provided and includes:
a processor; and
a transceiver connected with the processor,
where the processor is configured to load and execute executable instructions, thereby implementing the method for switching the CSI processing mode as described in the above aspects.

According to another aspect of embodiments of this disclosure, a network device is provided and includes:
a processor; and
a transceiver connected with the processor,
where the processor is configured to load and execute executable instructions, thereby implementing the method for switching the CSI processing mode as described in the above aspects.

It should be understood that the foregoing general description and the following detailed description are exemplary and explanatory only, and do not limit this disclosure.

### BRIEF DESCRIPTION OF THE DRAWINGS

In order to more clearly illustrate the technical solutions according to some embodiments of this disclosure, the drawings to be used in the description of some embodiments will be briefly introduced below. Apparently, the drawings in the following description are only some embodiments of this disclosure. For those of ordinary skill in the art, other drawings can also be obtained based on these drawings without creative efforts.

FIG. 1 is a block diagram of a communication system according to an exemplary embodiment.

FIG. 2 is a flow chart of a method for switching CSI processing mode according to an exemplary embodiment.

FIG. 3 is a flow chart of a method for switching CSI processing mode according to another exemplary embodiment.

FIG. 4 is a flow chart of a method for switching CSI processing mode according to another exemplary embodiment.

FIG. 5 is a flow chart of a method for switching CSI processing mode according to another exemplary embodiment.

FIG. 6 is a flow chart of a method for switching CSI processing mode according to another exemplary embodiment.

FIG. 7 is a flow chart of a method for switching CSI processing mode according to another exemplary embodiment.

FIG. 8 is a flow chart of a method for switching CSI processing mode according to another exemplary embodiment.

FIG. 9 is a flowchart of a method for switching CSI processing mode according to another exemplary embodiment.

FIG. 10 is a block diagram of an apparatus for switching CSI processing mode according to an exemplary embodiment.

FIG. 11 is a block diagram of an apparatus for switching CSI processing mode according to another exemplary embodiment.

FIG. 12 is a block diagram of an apparatus for switching CSI processing mode according to another exemplary embodiment.

FIG. 13 is a schematic structural diagram of a terminal according to an exemplary embodiment.

FIG. 14 is a schematic structural diagram of a network device according to an exemplary embodiment.

### DETAILED DESCRIPTION

Exemplary embodiments will be described in detail herein, examples of which are illustrated in the accompanying drawings. When the following description refers to the drawings, the same numbers in different drawings refer to the same or similar elements unless otherwise indicated. The implementations described in the following exemplary embodiments do not represent all implementations consistent with embodiments of this disclosure. Rather, they are merely examples of apparatuses and methods consistent with some aspects of embodiments of this disclosure as detailed in the appended claims.

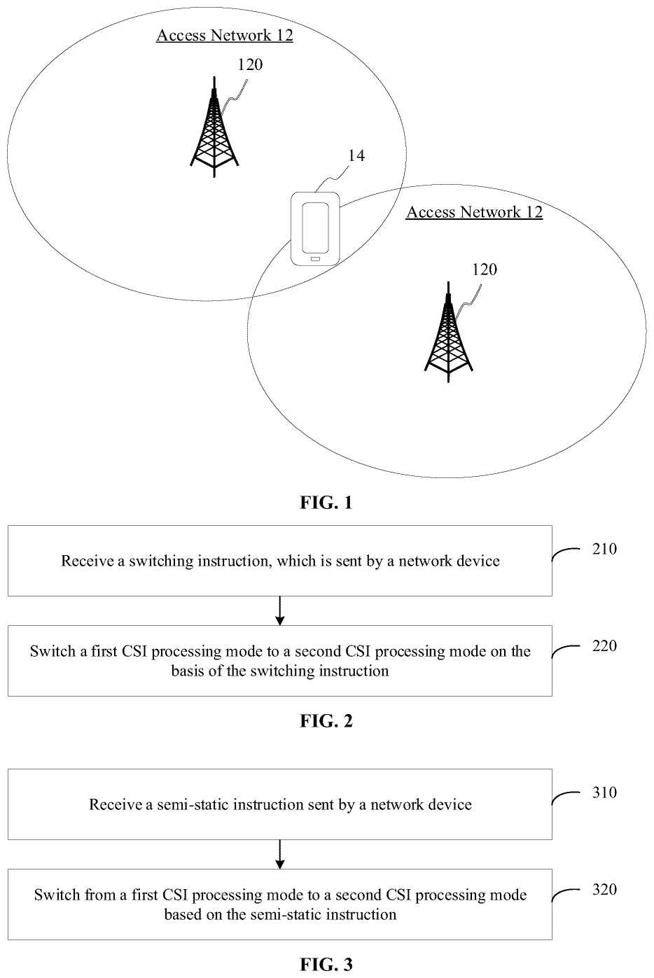

FIG. 1 shows a block diagram of a communication system according to an exemplary embodiment of this disclosure. The communication system may include: an access network 12 and a user terminal 14.

The access network 12 includes several network devices 120. The network device (also called access network device) 120 may be a base station, which is a device deployed in the access network to provide wireless communication functions for user terminals (referred to as “terminals”) 14. The base station can include various forms of macro base stations, micro base stations, relay stations, access points, and the like. In systems using different wireless access technologies, the names of devices with base station functions may be different. For example, in the LTE (Long Term Evolution) system, it is called eNodeB or eNB; in 5G NR (New Radio) system, it is called gNodeB or gNB. As communications technology evolves, the term “base station” may change. For convenience of description in the embodiments of this disclosure, the above-mentioned devices that provide wireless communication functions for the user terminal 14 are collectively referred to as network device.

The user terminal 14 may include various handheld devices, vehicle-mounted devices, wearable devices, computing devices with wireless communication functions or other processing devices connected to wireless modems, as well as various forms of user equipment, MS (Mobile Station), terminal device and so on. For convenience of description, the devices mentioned above are collectively referred to as user terminals. The network device 120 and the user terminal 14 communicate with each other through some air interface technology, such as the Uu interface.

For example, there are two communication scenarios between the network device 120 and the user terminal 14: an uplink communication scenario and a downlink communication scenario. Herein, uplink communication refers to sending signals to the network device 120, and downlink communication refers to sending signals to the user terminal 14.

The technical solutions according to the embodiments of this disclosure can be applied to various communication systems, such as: GSM (Global System of Mobile Communication) system, CDMA (Code Division Multiple Access) system, WCDMA (Wideband Code Division Multiple Access) system, GPRS (General Packet Radio Service), LTE system, LTE FDD (Frequency Division Duplex) system, LTE TDD (Time Division Duplex) system, LTE-A (Advanced Long Term Evolution) system, NR system, evolution system of NR system, LTE-U (LTE-based access to Unlicensed spectrum) system, NR-U system, UMTS (Universal Mobile Telecommunication System), WiMAX (Worldwide Interoperability for Microwave Access) communication system, WLAN (Wireless Local Area Networks), WiFi (Wireless Fidelity), next-generation communication systems or other communication systems.

Generally speaking, traditional communication systems support a limited number of connections and are easy to be implemented. However, with the development of communication technology, mobile communication systems will not only support traditional communication, but also support, for example, D2D (Device to Device) communication, M2M (Machine to Machine) communication, MTC (Machine Type Communication), V2V (Vehicle to Vehicle) communication, V2X (Vehicle to Everything) system, and the like. Embodiments of this disclosure may also be applied to these communication systems.

FIG. 2 shows a flow chart of a method for switching CSI processing mode according to an exemplary embodiment of this disclosure. The method is applied to the terminal of the communication system shown in FIG. 1 and includes the followings.

In step 210, a switching instruction sent by a network device is received.

Optionally, the switching instruction is a semi-static instruction or a dynamic instruction.

Exemplarily, the terminal receives a semi-static instruction sent by the network device, and the semi-static instruction is indicative of the terminal to perform CSI feedback according to the CSI processing mode indicated by the switching instruction within a period of time.

Exemplarily, the terminal receives a dynamic instruction sent by the network device, and the dynamic instruction is indicative of the terminal to perform the current CSI feedback according to the CSI processing mode indicated by the switching instruction.

Optionally, the above switching instruction is carried in DCI (Downlink Control Information). For example, an information field of the switching instruction is defined in the DCI, so that the terminal receives the DCI sent by the network device and obtains the switching instruction from the information field in the DCI.

In step 220, a first CSI processing mode is switched to a second CSI processing mode based on the switching instruction.

Exemplarily, the terminal switches from the first CSI processing mode to the second CSI processing mode based on the indication in the information field of the switching instruction in the DCI. Herein, the CSI processing mode refers to a mode of feedback to CSI.

In some embodiments, the first CSI processing mode is an AI-based CSI processing mode, and the second CSI processing mode is a CSI processing mode other than the AI-based CSI processing mode; or the second CSI processing mode is an AI-based CSI processing mode, and the first CSI processing mode is a CSI processing mode other than the AI-based CSI processing mode. For example, the above-mentioned other CSI processing modes may be traditional CSI processing modes. Optionally, a delay corresponding to the AI-based CSI processing mode is less than a delay corresponding to the other CSI processing modes mentioned above. In other words, the terminal supports switching between different CSI processing modes.

In some other embodiments, the first CSI processing mode is an AI-based CSI processing mode corresponding to a first AI processing capability, and the second CSI processing mode is an AI-based CSI processing mode corresponding to a second AI processing capability, where a delay corresponding to the first AI processing capability is less than a delay corresponding to the second AI processing capability, or the delay corresponding to the first AI processing capability is greater than the delay corresponding to the second AI processing capability. In other words, the terminal supports switching between different CSI processing modes corresponding to different AI processing capabilities.

In some other embodiments, the first CSI processing mode is a CSI processing mode based on a first AI model, and the second CSI processing mode is a CSI processing mode based on a second AI model. In other words, the terminal supports switching between different CSI processing modes corresponding to different AI models.

Optionally, the first AI model is an AI model corresponding to a first channel environment, and the second AI model is an AI model corresponding to a second channel environment, where a transmission rate corresponding to the first channel environment is higher than a transmission rate corresponding to the second channel environment, or the transmission rate corresponding to the first channel environment is lower than the transmission rate corresponding to the second channel environment.

Optionally, the first AI model is an AI model corresponding to a first AI processing capability, and the second AI model is an AI model corresponding to a second AI processing capability, where a delay corresponding to the first AI processing capability is less than a delay corresponding to the second AI processing capability, or the delay corresponding to the first AI processing capability is greater than the delay corresponding to the second AI processing capability.

In other words, the above-mentioned different AI models may be designed based on different channel environments or different AI processing capabilities, so that the terminal can switch to a CSI processing mode that is consistent with the actual application scenario for CSI feedback.

To sum up, based on the above method for switching CSI processing mode, the terminal can switch from the first CSI processing mode to the second CSI processing mode based on the switching instruction of the network device, thereby supporting the switching of CSI processing mode for the terminal. For example, the terminal can switch from an AI-based CSI processing mode to another CSI processing mode; for another example, the terminal can also switch from another CSI processing mode to the AI-based CSI processing mode; where the another CSI processing mode refers to a CSI processing mode other than the AI-based CSI processing mode.

For example, the switching of CSI processing mode may include the following four triggering manners.

First manner is semi-static switching triggered by the network device.

Second manner is dynamic switching triggered by the network device.

Third manner is semi-static switching triggered by the terminal.

Fourth manner is dynamic switching triggered by the terminal.

As shown in FIG. 3, in case of semi-static switching of CSI processing mode triggered by the network device, the method for switching CSI processing mode includes the followings.

In step 310, the terminal receives a semi-static instruction sent by the network device.

Optionally, in the case where the first CSI processing mode is an AI-based CSI processing mode, and the second CSI processing mode is a CSI processing mode other than the AI-based CSI processing mode, the above-mentioned semi-static instruction is a switching instruction sent by the network device to the terminal when feedback probability of the terminal increases upon using AI-based CSI compression. Herein, the feedback of the terminal upon using the AI-based CSI compression refers to the feedback on whether the data is sent correctly.

Optionally, the first CSI processing mode is an AI-based CSI processing mode corresponding to a first AI processing capability, and the second CSI processing mode is an AI-based CSI processing mode corresponding to a second AI processing capability. When a delay corresponding to the first AI processing capability is less than a delay corresponding to the second AI processing capability, the semi-static instruction is a switching instruction sent by the network device to the terminal when the delay required by a terminal service is greater than the maximum delay corresponding to the first AI processing capability. When the delay corresponding to the first AI processing capability is greater than the delay corresponding to the second AI processing capability, the semi-static instruction is a switching instruction sent by the network device to the terminal when the delay required by the terminal service is less than the minimum delay corresponding to the first AI processing capability. Herein, the delay required by the terminal service is indicative of a delay allowed in the CSI processing procedure corresponding to the service. For example, the delay required by the terminal service may be a delay range.

For example, the above-mentioned second CSI processing mode may be determined by the network device based on the delay required by the terminal service. In other words, the second CSI processing mode is a CSI processing mode where the delay corresponding to the second AI processing capability matches the delay required by the terminal service.

Optionally, the first CSI processing mode is a CSI processing mode based on a first AI model corresponding to a first channel environment, and the second CSI processing mode is a CSI processing mode based on a second AI model corresponding to a second channel environment. When a transmission rate corresponding to the first channel environment is higher than a transmission rate corresponding to the second channel environment, the semi-static instruction is a switching instruction sent by the network device to the terminal when the feedback probability of the terminal increases upon using the AI-based CSI compression.

Optionally, the first CSI processing mode is a CSI processing mode based on a first AI model corresponding to a first AI processing capability, and the second CSI processing mode is a CSI processing mode based on a second AI model corresponding to a second AI processing capability. When a delay corresponding to the first AI processing capability is less than a delay corresponding to the second AI processing capability, the semi-static instruction is a switching instruction sent by the network device to the terminal when the feedback probability of the terminal increases upon using AI-based CSI compression.

In step 320, the terminal switches from the first CSI processing mode to the second CSI processing mode based on the semi-static instruction.

To sum up, the method for switching CSI processing mode according to some embodiments supports semi-static switching of CSI processing mode triggered by the network device. The network device configures, based on the AI processing capability of the terminal or the channel environment, the terminal with a CSI processing mode meeting the actual application scenario. In addition, less signaling resources can be consumed by controlling the switching of CSI processing mode through the semi-static instruction, thereby saving signaling resources.

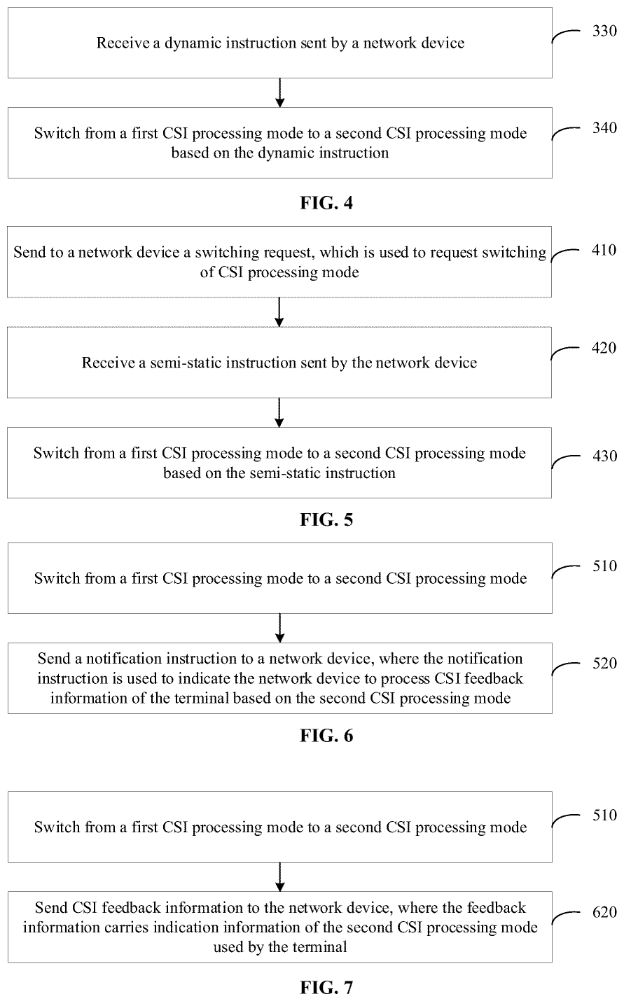

As shown in FIG. 4, in case of dynamic switching of CSI processing mode triggered by the network device, the method for switching CSI processing mode includes the followings.

In step 330, the terminal receives a dynamic instruction sent by the network device.

For example, the above dynamic instruction is a switching instruction sent by the network device to the terminal based on an AI processing capability of the terminal and a delay required by the current terminal service. Alternatively, the above dynamic instruction is a switching instruction sent by the network device to the terminal based on a current channel environment and the delay required by the current terminal service.

For example, when the terminal uses the first CSI processing mode for CSI feedback, the above dynamic instruction is a switching instruction sent by the network device to the terminal when the terminal supports the second CSI processing mode and a delay corresponding to the second CSI processing mode matches the delay required by the current terminal service.

For another example, when the terminal uses the first CSI processing mode for CSI feedback, the above dynamic instruction is a switching instruction sent by the network device to the terminal when the terminal supports the second CSI processing mode and a transmission rate of the current channel environment corresponding to the second CSI processing mode matches the delay required by the terminal service.

In step 340, the terminal switches from the first CSI processing mode to the second CSI processing mode based on the dynamic instruction.

To sum up, the method for switching CSI processing mode according to some embodiments supports dynamic switching of CSI processing mode triggered by the network device. The network device configures, based on the AI processing capability of the terminal or the channel environment, the terminal with a CSI processing mode meeting the actual application scenario. In addition, each CSI feedback can match the delay required by the terminal service or the transmission rate of the channel environment through flexible switching of CSI processing mode controlled by the dynamic instruction, thereby achieving more effective CSI feedback.

As shown in FIG. 5, in case of semi-static switching of CSI processing mode triggered by the terminal, the method for switching CSI processing mode includes the followings.

In step 410, the terminal sends a switching request to the network device, where the switching request is used to request switching of CSI processing mode.

The terminal sends the switching request to the network device based on a matching degree between an AI processing capability of the terminal and a delay required by the terminal service; or, the terminal sends the switching request to the network device based on a matching degree between a transmission rate corresponding to the current channel environment and the delay required by the terminal service. Herein, the delay required by the terminal service is indicative of a delay allowed in the CSI processing procedure corresponding to the service.

For example, the matching degree is indicative of that the delay corresponding to the AI processing capability matches the delay required by the terminal service, or that the delay corresponding to the AI processing capability does not match the delay required by the terminal service. In some embodiments, the situation where the delay corresponding to the AI processing capability matches the delay required by the terminal service includes at least one of the following:
the delay corresponding to the AI processing capability is the same as the delay required by terminal service; and
the delay corresponding to the AI processing capability is within a delay range required by terminal service.

The situation where the delay corresponding to the AI processing capability does not match the delay required by the terminal service includes at least one of the following:
the delay corresponding to the AI processing capability is greater than a maximum delay required by the terminal service;
the delay corresponding to the AI processing capability is less than a minimum delay required by terminal service.

For example, the matching degree is indicative of that the transmission rate corresponding to the channel environment matches the delay required by the terminal service, or that the transmission rate corresponding to the channel environment does not match the delay required by the terminal service.

Optionally, when the terminal uses an AI-based CSI processing mode, if the delay corresponding to the AI processing capability of the terminal is less than the minimum delay required by the terminal service, that is, if the AI processing capability of the terminal does not match the delay required by the terminal service, the terminal sends the switching request to the network device.

For example, the switching request is used to request switching to a CSI processing mode other than the AI-based CSI processing mode; or, the switching request is used to request switching to an AI-based CSI processing mode in which a delay corresponding to the AI processing capability matches the delay required by the terminal service.

Optionally, when the terminal uses an AI-based CSI processing mode, if the delay corresponding to the AI processing capability of the terminal is greater than the maximum delay required by the terminal service, that is, if the AI processing capability of the terminal does not match the delay required by the terminal service, the terminal sends the switching request to the network device.

For example, the switching request is used to request switching to an AI-based CSI processing mode in which a delay corresponding to the AI processing capability matches the delay required by the terminal service.

Optionally, when the transmission rate corresponding to the current channel environment does not match the delay required by the terminal service, the terminal sends the switching request to the network device.

For example, the switching request is used to request switching to an AI-based CSI processing mode in which the transmission rate corresponding to the channel environment matches the delay required by the terminal service.

In some other embodiments, if the delay corresponding to the AI processing capability matches the delay required by the terminal service, or the transmission rate corresponding to the channel environment matches the delay required by the terminal service, the terminal does not send the switching request to the network device. In other words, the terminal continues to use the current AI-based CSI processing mode, or the terminal continues to use a current CSI processing mode other than the AI-based CSI processing mode.

In step 420, the terminal receives a semi-static instruction sent by the network device.

Exemplarily, the terminal receives the semi-static instruction sent by the network device based on the switching request.

In step 430, the terminal switches from the first CSI processing mode to the second CSI processing mode based on the semi-static instruction.

To sum up, the method for switching CSI processing mode according to some embodiments supports semi-static switching of CSI processing mode triggered by the terminal. Based on its own AI processing capability or channel environment, the terminal can request switching to a CSI processing mode, that meets the actual application scenario, for CSI feedback. In addition, less signaling resources can be consumed by controlling the switching of CSI processing mode through the semi-static instruction, thereby saving signaling resources.

As shown in FIG. 6, in case of dynamic switching of CSI processing mode triggered by the terminal, the method for switching CSI processing mode includes the followings.

In step 510, the terminal switches from a first CSI processing mode to a second CSI processing mode.

For example, the terminal switches from the first CSI processing mode to the second CSI processing mode based on a delay required by a terminal service. In other words, the terminal switches from the first CSI processing mode to the second CSI processing mode that matches the delay required by the terminal service.

Optionally, the first CSI processing mode is an AI-based CSI processing mode, and the second CSI processing mode is a CSI processing mode other than the AI-based CSI processing mode; or, the second CSI processing mode is an AI-based CSI processing mode, and the first CSI processing mode is a CSI processing mode other than the AI-based CSI processing mode. For example, the above-mentioned other CSI processing mode may be a traditional CSI processing mode. Optionally, a delay corresponding to the AI-based CSI processing mode is less than a delay corresponding to the above-mentioned other CSI processing mode.

Optionally, the first CSI processing mode is an AI-based CSI processing mode corresponding to a first AI processing capability, and the second CSI processing mode is an AI-based CSI processing mode corresponding to a second AI processing capability, where a delay corresponding to the first AI processing capability is less than a delay corresponding to the second AI processing capability; or, the delay corresponding to the first AI processing capability is greater than the delay corresponding to the second AI processing capability.

Optionally, the first CSI processing mode is a CSI processing mode based on a first AI model, and the second CSI processing mode is a CSI processing mode based on a second AI model; where the first AI model is an AI model corresponding to a first AI processing capability, and the second AI model is an AI model corresponding to a second AI processing capability; a delay corresponding to the first AI processing capability is less than a delay corresponding to the second AI processing capability, or the delay corresponding to the first AI processing capability is greater than the delay corresponding to the second AI processing capability.

Exemplarily, the terminal switches from the first CSI processing mode to the second CSI processing mode based on a transmission rate corresponding to environment of a used channel. In other words, the terminal switches from the first CSI processing mode to the second CSI processing mode that matches the transmission rate corresponding to the channel environment.

Optionally, the first CSI processing mode is a CSI processing mode based on a first AI model, and the second CSI processing mode is a CSI processing mode based on a second AI model; the first AI model is an AI model corresponding to a first channel environment; and the second AI model is an AI model corresponding to a second channel environment; where a transmission rate corresponding to the first channel environment is higher than a transmission rate corresponding to the second channel environment; or, the transmission rate corresponding to the first channel environment is lower than the transmission rate corresponding to the second channel environment.

In step 520, the terminal sends a notification instruction to the network device, where the notification instruction is used to indicate the network device to process CSI feedback information of the terminal based on the second CSI processing mode.

After switching to the second CSI processing mode, the terminal notifies the network device that the terminal switches from the first CSI processing mode to the second CSI processing mode, so that the network device processes the CSI feedback information of the terminal based on the second CSI processing mode.

Exemplarily, after sending the notification instruction to the network device, the terminal further sends the CSI feedback information to the network device.

In some other embodiments, the terminal can carry indication information of the CSI processing mode through CSI feedback information. For example, as shown in FIG. 7, step 520 can be replaced with step 620 as follows.

In step 620, the terminal sends CSI feedback information to the network device, where the feedback information carries indication information of the second CSI processing mode used by the terminal.

While performing feedback processing on CSI, the terminal further carries indication information of the second CSI processing mode, after being switched to by the terminal, in the feedback information, thereby notifying, through the indication information, the network device to process the feedback information of the terminal based on the second CSI processing mode.

To sum up, the method for switching CSI processing mode according to some embodiments supports dynamic switching of CSI processing mode triggered by the terminal. The terminal switches the CSI processing mode based on its own AI processing capabilities or channel environment, and notifies the network device. In addition, each CSI feedback can match the delay required by the terminal service or the transmission rate of the channel environment through flexible switching of CSI processing mode controlled by the dynamic instruction, thereby achieving more effective CSI feedback.

FIG. 8 shows a flow chart of a method for switching CSI processing mode according to an exemplary embodiment of this disclosure. The method is applied to the network device of the communication system shown in FIG. 1 and includes the followings.

In step 710, a switching instruction is sent to the terminal, where the switching instruction is used to indicate the terminal to switch from a first CSI processing mode to a second CSI processing mode.

Optionally, the switching instruction is a semi-static instruction or a dynamic instruction.

For example, the network device sends a semi-static instruction to the terminal, and the semi-static instruction is used to indicate the terminal to perform CSI feedback according to the CSI processing mode indicated by the switching instruction within a period of time.

For example, the network device sends a dynamic instruction to the terminal, and the dynamic instruction is used to indicate the terminal to perform current CSI feedback according to the CSI processing mode indicated by the switching instruction.

Optionally, the above switching instruction is carried in DCI. Exemplarily, the network device sends the switching instruction through an information field of the DCI.

In some embodiments, the first CSI processing mode is an AI-based CSI processing mode, and the second CSI processing mode is a CSI processing mode other than the AI-based CSI processing mode; or the second CSI processing mode is an AI-based CSI processing mode, and the first CSI processing mode is a CSI processing mode other than the AI-based CSI processing mode. For example, the above-mentioned other CSI processing modes may be traditional CSI processing modes. Optionally, a delay corresponding to the AI-based CSI processing mode is less than a delay corresponding to the other CSI processing modes mentioned above. In other words, the terminal supports switching between different CSI processing modes.

In some other embodiments, the first CSI processing mode is an AI-based CSI processing mode corresponding to a first AI processing capability, and the second CSI processing mode is an AI-based CSI processing mode corresponding to a second AI processing capability, where a delay corresponding to the first AI processing capability is less than a delay corresponding to the second AI processing capability, or the delay corresponding to the first AI processing capability is greater than the delay corresponding to the second AI processing capability. In other words, the terminal supports switching between different CSI processing modes corresponding to different AI processing capabilities.

In some other embodiments, the first CSI processing mode is a CSI processing mode based on a first AI model, and the second CSI processing mode is a CSI processing mode based on a second AI model. In other words, the terminal supports switching between different CSI processing modes corresponding to different AI models.

Optionally, the first AI model is an AI model corresponding to a first channel environment, and the second AI model is an AI model corresponding to a second channel environment, where a transmission rate corresponding to the first channel environment is higher than a transmission rate corresponding to the second channel environment, or the transmission rate corresponding to the first channel environment is lower than the transmission rate corresponding to the second channel environment.

Optionally, the first AI model is an AI model corresponding to a first AI processing capability, and the second AI model is an AI model corresponding to a second AI processing capability, where a delay corresponding to the first AI processing capability is less than a delay corresponding to the second AI processing capability, or the delay corresponding to the first AI processing capability is greater than the delay corresponding to the second AI processing capability.

In other words, the above-mentioned different AI models may be designed based on different channel environments or different AI processing capabilities, so that the terminal can switch to a CSI processing mode that is consistent with the actual application scenario for CSI feedback.

To sum up, based on the above method for switching CSI processing mode, the network device sends the switching instruction to the terminal, and indicates, through the switching instruction, the terminal to switch from the used first CSI processing mode to the second CSI processing mode, thereby supporting the switching of CSI processing mode for the terminal. For example, the terminal can switch from an AI-based CSI processing mode to another CSI processing mode; for another example, the terminal can also switch from another CSI processing mode to the AI-based CSI processing mode; where the another CSI processing mode refers to a CSI processing mode other than the AI-based CSI processing mode.

For example, the switching of CSI processing mode may include the following four triggering manners.

First manner is semi-static switching triggered by the network device.

Second manner is dynamic switching triggered by the network device.

Third manner is semi-static switching triggered by the terminal.

Fourth manner is dynamic switching triggered by the terminal.

In case of semi-static switching of CSI processing mode triggered by the network device, the method for switching CSI processing mode includes: the network device sends a semi-static instruction to the terminal.

Optionally, in the case where the first CSI processing mode is an AI-based CSI processing mode, and the second CSI processing mode is a CSI processing mode other than the AI-based CSI processing mode, the above-mentioned semi-static instruction is a switching instruction sent by the network device to the terminal when feedback probability of the terminal increases upon using AI-based CSI compression. That is, when the feedback probability of the terminal increases upon using AI-based CSI compression, the network device sends the semi-static instruction to the terminal, thereby switching from the first CSI processing mode to the second CSI processing mode. Herein, the feedback of the terminal upon using the AI-based CSI compression refers to the feedback on whether the data is sent correctly.

Optionally, the first CSI processing mode is an AI-based CSI processing mode corresponding to a first AI processing capability, and the second CSI processing mode is an AI-based CSI processing mode corresponding to a second AI processing capability. When a delay corresponding to the first AI processing capability is less than a delay corresponding to the second AI processing capability, the semi-static instruction is a switching instruction sent by the network device to the terminal when the delay required by a terminal service is greater than the maximum delay corresponding to the first AI processing capability. When the delay corresponding to the first AI processing capability is greater than the delay corresponding to the second AI processing capability, the semi-static instruction is a switching instruction sent by the network device to the terminal when the delay required by the terminal service is less than the minimum delay corresponding to the first AI processing capability.

In other words, if the delay corresponding to the first AI processing capability is less than the delay corresponding to the second AI processing capability, the network device sends the semi-static instruction to the terminal in the case where the delay required by the terminal service is greater than the maximum delay corresponding to the first AI processing capability, thereby indicating the terminal to switch from the first CSI processing mode to the second CSI processing mode. If the delay corresponding to the first AI processing capability is greater than the delay corresponding to the second AI processing capability, the network device sends the semi-static instruction to the terminal in the case where the delay required by the terminal service is less than the minimum delay corresponding to the first AI processing capability, thereby indicating the terminal to switch from the first CSI processing mode to the second CSI processing mode. Herein, the delay required by the terminal service is indicative of a delay allowed in the CSI processing procedure corresponding to the service. For example, the delay required by the terminal service may be a delay range.

For example, the above-mentioned second CSI processing mode may be determined by the network device based on the delay required by the terminal service. In other words, the second CSI processing mode is a CSI processing mode where the delay corresponding to the second AI processing capability matches the delay required by the terminal service.

Optionally, the first CSI processing mode is a CSI processing mode based on a first AI model corresponding to a first channel environment, and the second CSI processing mode is a CSI processing mode based on a second AI model corresponding to a second channel environment. When a transmission rate corresponding to the first channel environment is higher than a transmission rate corresponding to the second channel environment, the semi-static instruction is a switching instruction sent by the network device to the terminal when the feedback probability of the terminal increases upon using the AI-based CSI compression.

Optionally, the first CSI processing mode is a CSI processing mode based on a first AI model corresponding to a first AI processing capability, and the second CSI processing mode is a CSI processing mode based on a second AI model corresponding to a second AI processing capability. When a delay corresponding to the first AI processing capability is less than a delay corresponding to the second AI processing capability, the semi-static instruction is a switching instruction sent by the network device to the terminal when the feedback probability of the terminal increases upon using AI-based CSI compression.

In other words, in the above two situations, when the feedback probability of the terminal increases upon using the AI-based CSI compression, the network device sends a semi-static instruction to the terminal so that the terminal switches from the first CSI processing mode to the second CSI processing mode.

To sum up, the method for switching CSI processing mode according to some embodiments supports semi-static switching of CSI processing mode triggered by the network device. The network device configures, based on the AI processing capability of the terminal or the channel environment, the terminal with a CSI processing mode meeting the actual application scenario. In addition, less signaling resources can be consumed by controlling the switching of CSI processing mode through the semi-static instruction, thereby saving signaling resources.

In case of dynamic switching of CSI processing mode triggered by the network device, the method for switching CSI processing mode includes: the network device sends a dynamic instruction to the terminal.

Exemplarily, the above dynamic instruction is a switching instruction sent by the network device to the terminal based on an AI processing capability of the terminal and a delay required by the current terminal service. Alternatively, the above dynamic instruction is a switching instruction sent by the network device to the terminal based on a current channel environment and the delay required by the current terminal service. In other words, the network device sends the dynamic instruction to the terminal based on the AI processing capability of the terminal and the delay required by the current terminal service; or, the network device sends the dynamic instruction to the terminal based on the current channel environment and the delay required by the current terminal service.

For example, when the terminal uses the first CSI processing mode for CSI feedback, the above dynamic instruction is a switching instruction sent by the network device to the terminal when the terminal supports the second CSI processing mode and a delay corresponding to the second CSI processing mode matches the delay required by the current terminal service.

For another example, when the terminal uses the first CSI processing mode for CSI feedback, the above dynamic instruction is a switching instruction sent by the network device to the terminal when the terminal supports the second CSI processing mode and a transmission rate of the current channel environment corresponding to the second CSI processing mode matches the delay required by the terminal service.

To sum up, the method for switching CSI processing mode according to some embodiments supports dynamic switching of CSI processing mode triggered by the network device. The network device configures, based on the AI processing capability of the terminal or the channel environment, the terminal with a CSI processing mode meeting the actual application scenario. In addition, each CSI feedback can match the delay required by the terminal service or the transmission rate of the channel environment through flexible switching of CSI processing mode controlled by the dynamic instruction, thereby achieving more effective CSI feedback.

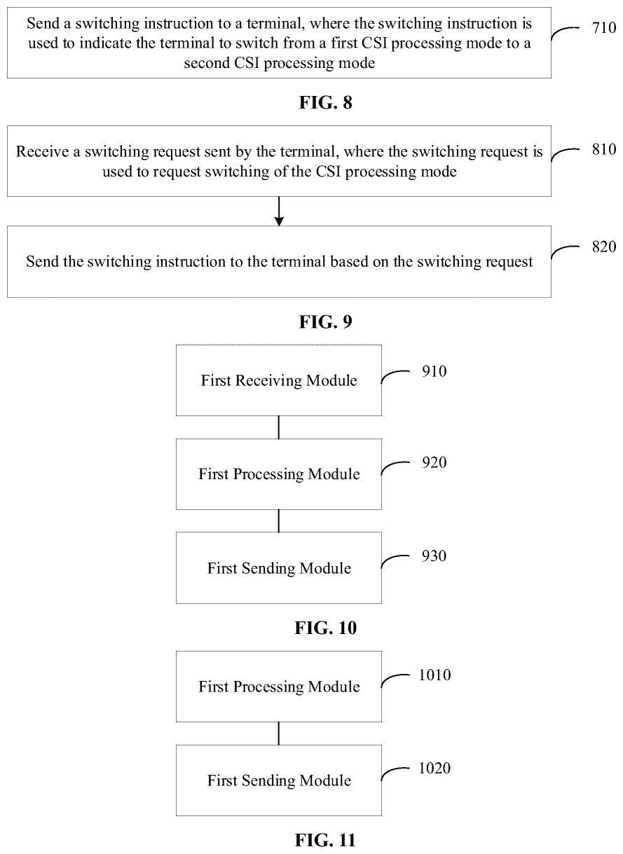

As shown in FIG. 9, in case of semi-static switching of CSI processing mode triggered by the terminal, the method for switching CSI processing mode includes the followings.

In step 810, the network device receives a switching request sent by the terminal, where the switching request is used to request switching of the CSI processing mode.

The above switching request is sent by the terminal to the network device based on a matching degree between an AI processing capability of the terminal and a delay required by the terminal service; or, the above switching request is sent by the terminal to the network device based on a matching degree between a transmission rate corresponding to the current channel environment and the delay required by the terminal service. The degree of matching between the delays sent to network devices. Herein, the delay required by the terminal service is indicative of a delay allowed in the CSI processing procedure corresponding to the service.

For example, the matching degree is indicative of that the delay corresponding to the AI processing capability matches the delay required by the terminal service, or that the delay corresponding to the AI processing capability does not match the delay required by the terminal service. In some embodiments, the situation where the delay corresponding to the AI processing capability matches the delay required by the terminal service includes at least one of the following:
the delay corresponding to the AI processing capability is the same as the delay required by terminal service; and
the delay corresponding to the AI processing capability is within a delay range required by terminal service.

The situation where the delay corresponding to the AI processing capability does not match the delay required by the terminal service includes at least one of the following:
the delay corresponding to the AI processing capability is greater than a maximum delay required by the terminal service;
the delay corresponding to the AI processing capability is less than a minimum delay required by terminal service.

For example, the matching degree is indicative of that the transmission rate corresponding to the channel environment matches the delay required by the terminal service, or that the transmission rate corresponding to the channel environment does not match the delay required by the terminal service.

Optionally, the switching request is sent by the terminal to the network device when it uses an AI-based CSI processing mode, and a delay corresponding to the AI processing capability of the terminal is less than the minimum delay required by the terminal service, that is, when the AI processing capability of the terminal does not match the delay required by the terminal service.

For example, the switching request is used to request switching to a CSI processing mode other than the AI-based CSI processing mode; or, the switching request is used to request switching to an AI-based CSI processing mode in which a delay corresponding to the AI processing capability matches the delay required by the terminal service.

Optionally, the switching request is sent by the terminal to the network device when it uses an AI-based CSI processing mode, and a delay corresponding to the AI processing capability of the terminal is greater than the maximum delay required by the terminal service, that is, when the AI processing capability of the terminal does not match the delay required by the terminal service.

For example, the switching request is used to request switching to an AI-based CSI processing mode in which a delay corresponding to the AI processing capability matches the delay required by the terminal service.

Optionally, the switching request is sent by the terminal to the network device when a transmission rate corresponding to the current channel environment does not match the delay required by the terminal service.

For example, the switching request is used to request switching to an AI-based CSI processing mode in which the transmission rate corresponding to the channel environment matches the delay required by the terminal service.

In step 820, the network device sends a switching instruction to the terminal based on the switching request.

To sum up, the method for switching CSI processing mode according to some embodiments supports semi-static switching of CSI processing mode triggered by the terminal. Based on its own AI processing capability or channel environment, the terminal can request switching to a CSI processing mode, that meets the actual application scenario, for CSI feedback. In addition, less signaling resources can be consumed by controlling the switching of CSI processing mode through the semi-static instruction, thereby saving signaling resources.

In case of dynamic switching of CSI processing mode triggered by the terminal, the method for switching CSI processing mode includes: the network device receives a notification instruction sent by the terminal, where the notification instruction is used to indicate the network device to process CSI feedback information of the terminal based on the second CSI processing mode. The notification instruction is sent to the network device after the terminal switches from the first CSI processing mode to the second CSI processing mode.

Exemplarily, the notification instruction is sent to the network device after the terminal switches from the first CSI processing mode to the second CSI processing mode based on a delay required by the terminal service. In other words, the notification instruction is sent to the network device after the terminal switches from the first CSI processing mode to the second CSI processing mode that matches the delay required by the terminal service.

Optionally, the first CSI processing mode is an AI-based CSI processing mode, and the second CSI processing mode is a CSI processing mode other than the AI-based CSI processing mode; or, the second CSI processing mode is an AI-based CSI processing mode, and the first CSI processing mode is a CSI processing mode other than the AI-based CSI processing mode. For example, the above-mentioned other CSI processing mode may be a traditional CSI processing mode. Optionally, a delay corresponding to the AI-based CSI processing mode is less than a delay corresponding to the above-mentioned other CSI processing mode.

Optionally, the first CSI processing mode is an AI-based CSI processing mode corresponding to a first AI processing capability, and the second CSI processing mode is an AI-based CSI processing mode corresponding to a second AI processing capability, where a delay corresponding to the first AI processing capability is less than a delay corresponding to the second AI processing capability; or, the delay corresponding to the first AI processing capability is greater than the delay corresponding to the second AI processing capability.

Optionally, the first CSI processing mode is a CSI processing mode based on a first AI model, and the second CSI processing mode is a CSI processing mode based on a second AI model; where the first AI model is an AI model corresponding to a first AI processing capability, and the second AI model is an AI model corresponding to a second AI processing capability; a delay corresponding to the first AI processing capability is less than a delay corresponding to the second AI processing capability, or the delay corresponding to the first AI processing capability is greater than the delay corresponding to the second AI processing capability.

Exemplarily, the notification instruction is sent to the network device after the terminal switches from the first CSI processing mode to the second CSI processing mode based on a transmission rate corresponding to environment of a used channel. In other words, the notification instruction is sent to the network device after the terminal switches from the first CSI processing mode to the second CSI processing mode that matches the transmission rate corresponding to the channel environment.

Optionally, the first CSI processing mode is a CSI processing mode based on a first AI model, and the second CSI processing mode is a CSI processing mode based on a second AI model; the first AI model is an AI model corresponding to a first channel environment; and the second AI model is an AI model corresponding to a second channel environment; where a transmission rate corresponding to the first channel environment is higher than a transmission rate corresponding to the second channel environment; or, the transmission rate corresponding to the first channel environment is lower than the transmission rate corresponding to the second channel environment.

After receiving the notification instruction, the network device processes the CSI feedback information of the terminal based on the second CSI processing mode.

In some embodiments, the terminal may carry indication information of the CSI processing mode through CSI feedback information. In other words, the network device receives the CSI feedback information sent by the terminal, where the feedback information carries indication information of the second CSI processing mode used by the terminal; and the network device processes the CSI feedback information of the terminal based on the second CSI processing mode indicated by the indication information.

To sum up, the method for switching CSI processing mode according to some embodiments supports dynamic switching of CSI processing mode triggered by the terminal. The terminal switches the CSI processing mode based on its own AI processing capabilities or channel environment, and notifies the network device. In addition, each CSI feedback can match the delay required by the terminal service or the transmission rate of the channel environment through flexible switching of CSI processing mode controlled by the dynamic instruction, thereby achieving more effective CSI feedback.

Exemplarily, the method for switching CSI processing mode according to the forgoing embodiments mainly includes the followings.

### Method I

In the first aspect, for a terminal that supports AI-based processing capabilities, the terminal is also to support traditional CSI processing modes, such as CQI (channel quality indicator) feedback modes and PMI (precoding matrix indicator) feedback modes based on type1, type2, and the like in the NR system. The AI-based CSI processing mode may be defined as the first CSI processing mode, and the CSI processing mode based on the traditional mode (that is, other CSI processing modes except the AI-based CSI processing mode) may be defined as the second CSI processing mode.

In the second aspect, the terminal supports switching between the first CSI processing mode and the second CSI processing mode.
1) It supports semi-static switching based on triggering of network. For example, if the network device acknowledges that, when AI-based CSI compression is used, the NACK feedback probability of the terminal increases, then the network device may configure the terminal to switch from the first CSI processing mode to the second CSI processing mode. For example, NACK indicates decompression failure.
2) It supports semi-static switching based on triggering of terminal. For example, the terminal may request the network device to switch from the first CSI processing mode to the second CSI processing based on the current AI processing load (i.e., the AI processing capability) and a matching degree of the processing delay requirement when using the AI-based CSI processing mode. The network device side may determine whether to switch the CSI processing mode according to the switching request of the terminal, and then reconfigure the CSI processing mode to the terminal after determination.
3) It supports dynamic switching based on triggering of network. Corresponding dynamic signaling may be defined. For example, a corresponding information field is defined in DCI and used to indicate the terminal to switch the CSI processing mode.
4) It supports dynamic switching based on triggering of terminal. When performing CSI processing, the terminal can dynamically select to use the first CSI processing mode or the second CSI processing mode, and indicate the same in the CSI feedback information. After receiving the CSI feedback information of the terminal, the network device first reads the CSI processing mode indicator (i.e., the indication information), and selects the corresponding CSI processing mode, for restoring information, according to the CSI processing mode indicator of the terminal.

### Method II

In the first aspect, for a terminal that supports AI-based processing capabilities, multiple levels of AI-based CSI processing capability may be defined, where different levels of AI processing capability correspond to different delay requirements. For example, the first AI processing capability corresponds to a lower processing delay, and the second AI processing capability corresponds to a higher processing delay.

In the second aspect, the terminal supports switching between different AI processing levels.
1) It supports semi-static switching based on triggering of network. For example, when the network device finds that the current service does not have strict delay requirements, the network device may configure the terminal to switch to an AI-based CSI processing mode corresponding to the second AI processing capability, thereby relaxing the processing requirements on the terminal.
2) It supports semi-static switching based on triggering of terminal. For example, the terminal may request the network device to switch to an AI-based CSI processing mode corresponding to the second AI processing capability based on the current AI processing load and the matching degree of processing delay requirements when using the AI-based CSI processing mode. The network device side may determine whether to switch the CSI processing mode according to the switching request of the terminal, and then reconfigure the CSI processing mode to the terminal after determination.
3) It supports dynamic switching based on triggering of network. Corresponding dynamic signaling may be defined. For example, a corresponding information field is defined in DCI and used to indicate the terminal to switch the CSI processing mode.
4) It supports dynamic switching based on triggering of terminal. When performing CSI processing, the terminal can dynamically choose to use the AI-based CSI processing mode corresponding to the first AI processing capability or the AI-based CSI processing mode corresponding to the second AI processing capability, and notify the network device in advance. The network device configures the CSI processing mode according to the switching request of the terminal.

### Method III

In the first aspect, for a terminal that supports AI processing capabilities, multiple AI processing models are defined, where different AI processing models may correspond to different channel environments, or different AI models may correspond to different AI processing capabilities. For example, the first AI model corresponds to a channel model that moves faster, and the second AI model corresponds to a relatively stationary channel model.

In the second aspect, the terminal supports switching between different AI processing models.
1) It supports semi-static switching based on triggering of network. For example, if the network device acknowledges that, when AI-based CSI compression is used, the NACK feedback probability of the terminal increases, then the network device may configure the terminal to switch the CSI processing mode based on the AI processing model.
2) It supports semi-static switching based on triggering of terminal. For example, the terminal may perform model switching based on the current AI processing load and a matching degree of the processing delay requirement when using the AI-based CSI processing mode, that is, switch from a CSI processing mode based on the first AI model to a CSI processing mode based on the second AI model. The network device side may determine whether to perform the model switching according to the switching request of the terminal, and then reconfigure the CSI processing mode to the terminal after determination.
3) It supports dynamic switching based on triggering of network. Corresponding dynamic signaling may be defined. For example, a corresponding information field is defined in DCI and used to indicate the terminal to switch the CSI processing mode.
4) It supports dynamic switching based on triggering of terminal. When performing CSI processing, the terminal can dynamically select whether to use the CSI processing mode based on the first AI model or the CSI processing mode based on the second AI model, and indicate the same in the CSI feedback information. After receiving the CSI feedback information from the terminal, the network first reads the CSI processing mode indicator, and selects the corresponding CSI processing mode, for restoring information, based on the CSI processing mode indicator.

To sum up, the method for switching CSI processing mode according to some embodiments supports semi-static switching and dynamic switching of CSI processing modes triggered by the terminal, and supports semi-static switching and dynamic switching of CSI processing modes triggered by the network device.

FIG. 10 shows a block diagram of an apparatus for switching CSI processing mode according to an exemplary embodiment of this disclosure. The apparatus can be implemented as part or all of the UE through software, hardware, or a combination thereof. The apparatus includes:
a first receiving module 910, configured to receive a switching instruction sent by a network device; and
a first processing module 920, configured to switch from a first CSI processing mode to a second CSI processing mode based on the switching instruction.

In some embodiments, the first CSI processing mode is a CSI processing mode based on a first AI model, and the second CSI processing mode is a CSI processing mode based on a second AI model.

In some embodiments, the first AI model is an AI model corresponding to a first channel environment, and the second AI model is an AI model corresponding to a second channel environment;
where transmission rate corresponding to the first channel environment is higher than a transmission rate corresponding to the second channel environment; or, a transmission rate corresponding to the first channel environment is lower than a transmission rate corresponding to the second channel environment.

In some embodiments, the first AI model is an AI model corresponding to a first AI processing capability, and the second AI model is an AI model corresponding to a second AI processing capability;
where a delay corresponding to the first AI processing capability is less than a delay corresponding to the second AI processing capability; or, a delay corresponding to the first AI processing capability is greater than a delay corresponding to the second AI processing capability.

In some embodiments, the first CSI processing mode is an AI-based CSI processing mode corresponding to a first AI processing capability, and the second CSI processing mode is an AI-based CSI processing mode corresponding to a second AI processing capability;
where a delay corresponding to the first AI processing capability is less than a delay corresponding to the second AI processing capability; or, a delay corresponding to the first AI processing capability is greater than a delay corresponding to the second AI processing capability.

In some embodiments, the first CSI processing mode is an AI-based CSI processing mode, and the second CSI processing mode is a CSI processing mode other than the AI-based CSI processing mode;
or, the second CSI processing mode is an AI-based CSI processing mode, and the first CSI processing mode is a CSI processing mode other than the AI-based CSI processing mode.

In some embodiments, the switching instruction is a semi-static instruction or a dynamic instruction.

In some embodiments, the apparatus further includes:
a first sending module 930, configured to send a switching request to the network device before receiving the switching instruction sent by the network device, where the switching request is used to request switching of the CSI processing mode.

In some embodiments, the switching instruction is carried in DCI.

FIG. 11 shows a block diagram of an apparatus for switching CSI processing mode according to another exemplary embodiment of this disclosure. The apparatus can be implemented as part or all of the UE through software, hardware, or a combination thereof. The apparatus includes:
a first processing module 1010, configured to switch from a first CSI processing mode to a second CSI processing mode; and
a first sending module 1020, configured to send a notification instruction to a network device, where the notification instruction is indicative of the network device to process CSI feedback information of the terminal based on the second CSI processing mode.

In some embodiments, the first CSI processing mode is a CSI processing mode based on a first AI model, and the second CSI processing mode is a CSI processing mode based on a second AI model.

In some embodiments, the first AI model is an AI model corresponding to a first channel environment, and the second AI model is an AI model corresponding to a second channel environment;
where a transmission rate corresponding to the first channel environment is higher than a transmission rate corresponding to the second channel environment; or, a transmission rate corresponding to the first channel environment is lower than a transmission rate corresponding to the second channel environment.

In some embodiments, the first AI model is an AI model corresponding to a first AI processing capability, and the second AI model is an AI model corresponding to a second AI processing capability;
where a delay corresponding to the first AI processing capability is less than a delay corresponding to the second AI processing capability; or, a delay corresponding to the first AI processing capability is greater than a delay corresponding to the second AI processing capability.

In some embodiments, the first CSI processing mode is an AI-based CSI processing mode corresponding to a first AI processing capability, and the second CSI processing mode is an AI-based CSI processing mode corresponding to a second AI processing capability;
where a delay corresponding to the first AI processing capability is less than a delay corresponding to the second AI processing capability; or, a delay corresponding to the first AI processing capability is greater than a delay corresponding to the second AI processing capability.

In some embodiments, the first CSI processing mode is an AI-based CSI processing mode, and the second CSI processing mode is a CSI processing mode other than the AI-based CSI processing mode;
or, the second CSI processing mode is an AI-based CSI processing mode, and the first CSI processing mode is a CSI processing mode other than the AI-based CSI processing mode.

In some embodiments, the first sending module 1020 is configured to send the CSI feedback information to the network device, where the feedback information carries indication information of the second CSI processing mode used by the terminal.

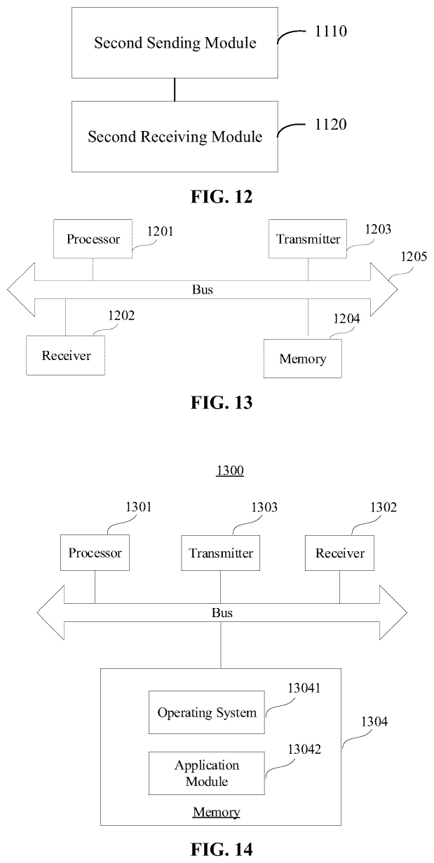

FIG. 12 shows a block diagram of an apparatus for switching CSI processing mode according to another exemplary embodiment of this disclosure. The apparatus can be implemented as part or all of the network device through software, hardware, or a combination thereof. The apparatus includes:
a second sending module 1110, configured to send a switching instruction to a terminal, where the switching instruction is indicative of the terminal to switch from a first CSI processing mode to a second CSI processing mode.

In some embodiments, the first CSI processing mode is a CSI processing mode based on a first AI model, and the second CSI processing mode is a CSI processing mode based on a second AI model.

In some embodiments, the first AI model is an AI model corresponding to a first channel environment, and the second AI model is an AI model corresponding to a second channel environment;
where a transmission rate corresponding to the first channel environment is higher than a transmission rate corresponding to the second channel environment; or, a transmission rate corresponding to the first channel environment is lower than a transmission rate corresponding to the second channel environment.

In some embodiments, the first AI model is an AI model corresponding to a first AI processing capability, and the second AI model is an AI model corresponding to a second AI processing capability;
where a delay corresponding to the first AI processing capability is less than a delay corresponding to the second AI processing capability; or, a delay corresponding to the first AI processing capability is greater than a delay corresponding to the second AI processing capability.

In some embodiments, the first CSI processing mode is an AI-based CSI processing mode corresponding to a first AI processing capability, and the second CSI processing mode is an AI-based CSI processing mode corresponding to a second AI processing capability;
where a delay corresponding to the first AI processing capability is less than a delay corresponding to the second AI processing capability; or, a delay corresponding to the first AI processing capability is greater than a delay corresponding to the second AI processing capability.

In some embodiments, the first CSI processing mode is an AI-based CSI processing mode, and the second CSI processing mode is a CSI processing mode other than the AI-based CSI processing mode;
or, the second CSI processing mode is an AI-based CSI processing mode, and the first CSI processing mode is a CSI processing mode other than the AI-based CSI processing mode.

In some embodiments, the switching instruction is a semi-static instruction or a dynamic instruction.

In some embodiments, the apparatus further includes:
a second receiving module 1120, configured to receive a switching request sent by the terminal before sending the switching instruction to the terminal, where the switching request is used to request switching of the CSI processing mode.

In some embodiments, the switching instruction is carried in DCI.

FIG. 13 shows a schematic structural diagram of a UE according to an exemplary embodiment of this disclosure. The UE includes: a processor 1201, a receiver 1202, a transmitter 1203, a memory 1204 and a bus 1205.

The processor 1201 includes one or more processing cores. The processor 1201 executes various functional applications and information processing by running software programs and modules.

The receiver 1202 and the transmitter 1203 can be implemented as a communication component, and the communication component can be a communication chip.

The memory 1204 is connected to processor 1201 through bus 1205.

The memory 1204 can be configured to store at least one instruction, and the processor 1201 is configured to execute the at least one instruction to implement each step in the above method embodiments.

Additionally, the memory 1204 may be implemented by any type of volatile or non-volatile storage device, or combination thereof, including but not limited to: magnetic or optical disks, EEPROM (Electrically Erasable Programmable Read Only Memory), EPROM (Erasable Programmable Read Only Memory), SRAM (Static Random-Access Memory), ROM (Read Only Memory), magnetic memory, flash memory, PROM (Programmable Read Only Memory).

In an exemplary embodiment, a non-transitory computer-readable storage medium including instructions, such as a memory including instructions, is further provided. The above instructions can be executed by a processor of the UE to implement the above-mentioned method for switching CSI processing mode. For example, the non-transitory computer-readable storage medium may be ROM, RAM (Random-Access Memory), CD-ROM (Compact Disc Read Only Memory), magnetic tape, floppy disk, optical data storage devices, and the like.

A non-transitory computer-readable storage medium is further provided. When the instructions in the non-transitory computer storage medium are executed by a processor of UE, the UE is enabled to perform the above-mentioned method for switching CSI processing mode.

FIG. 14 is a block diagram of a network device 1300 according to an exemplary embodiment. The network device 1300 may be a base station.

The network device 1300 may include: a processor 1301, a receiver 1302, a transmitter 1303, and a memory 1304. The receiver 1302, the transmitter 1303 and the memory 1304 are respectively connected to the processor 1301 through a bus.

The processor 1301 includes one or more processing cores, and the processor 1301 executes the method for switching CSI processing mode according to some embodiments of this disclosure by running software programs and modules. The memory 1304 may be configured to store software programs and modules. Specifically, the memory 1304 can store an operating system 13041 and an application module 13042 required for at least one function. The receiver 1302 is configured to receive communication data sent by other devices, and the transmitter 1303 is configured to send communication data to other devices.

Some exemplary embodiments of this disclosure further provide a computer-readable storage medium. The computer-readable storage medium stores at least one instruction, at least a program, a code set or an instruction set. The at least one instruction, the at least one program, the code set or the instruction set is loaded and executed by a processor to implement the method for switching CSI processing mode according to the above method embodiments.

Some exemplary embodiments of this disclosure further also provide a computer program product, the computer program product includes computer instructions, and the computer instructions are stored in a computer-readable storage medium. A processor of a computer device reads the computer instructions from the computer-readable storage medium, and executes the computer instructions, thereby causing the computer device to perform the method for switching CSI processing mode according to the above method embodiments.

It should be understood that “a/the plurality of” mentioned in this disclosure means two or more. The term “and/or” describes a relationship between related objects, indicating that there may be three relationships. For example, “A and/or B” may mean: A exists alone, both A and B exist, and B exists alone. The character “/” generally indicates that the related objects are in an “or” relationship.

Other embodiments of the disclosure will be readily apparent to those skilled in the art from consideration of the specification and practice of the invention disclosed herein. This disclosure is intended to cover any variations, uses, or adaptations of the disclosure that follow the general principles of the disclosure and include common sense or customary technical means in the art that are not disclosed in the disclosure. It is intended that the specification and examples be considered as exemplary only, with a true scope and spirit of the disclosure being indicated by the following claims.

It is to be understood that this disclosure is not limited to the precise structures described above and illustrated in the accompanying drawings, and various modifications and changes may be made without departing from the scope thereof. The scope of the disclosure is limited only by the appended claims.

1. A method for switching a channel status indicator (CSI) processing mode, being performed by a terminal and comprising:
receiving a switching instruction sent by a network device; and
switching, based on the switching instruction, from a first CSI processing mode to a second CSI processing mode.

2. The method according to claim 1, wherein:
the first CSI processing mode is a CSI processing mode based on a first artificial intelligence (AI) model, and the second CSI processing mode is a CSI processing mode based on a second AI model; or
the first CSI processing mode is an AI-based CSI processing mode, and the second CSI processing mode is a CSI processing mode other than the AI-based CSI processing mode; or,
the second CSI processing mode is an AI-based CSI processing mode, and the first CSI processing mode is a CSI processing mode other than the AI-based CSI processing mode.

3. The method according to claim 2, wherein:
the first AI model is an AI model corresponding to a first channel environment, and the second AI model is an AI model corresponding to a second channel environment;
wherein, a transmission rate corresponding to the first channel environment is different from a transmission rate corresponding to the second channel environment.

4. The method according to claim 2, wherein:
the first AI model is an AI model corresponding to a first AI processing capability, and the second AI model is an AI model corresponding to a second AI processing capability;
wherein, a delay corresponding to the first AI processing capability is different from a delay corresponding to the second AI processing capability.

5. The method according to claim 1, wherein:
the first CSI processing mode is an AI-based CSI processing mode corresponding to a first AI processing capability, and the second CSI processing mode is an AI-based CSI processing mode corresponding to a second AI processing capability;
wherein, a delay corresponding to the first AI processing capability is different from a delay corresponding to the second AI processing capability.

6.-9. (canceled)

10. A method for switching a channel status indicator (CSI) processing mode, being performed by a terminal and comprising:
switching from a first CSI processing mode to a second CSI processing mode; and
sending a notification instruction to a network device, wherein the notification instruction is used to indicate the network device to process CSI feedback information of the terminal based on the second CSI processing mode.

11. The method according to claim 10, wherein:
the first CSI processing mode is a CSI processing mode based on a first artificial intelligence (AI) model, and the second CSI processing mode is a CSI processing mode based on a second AI model.

12. The method according to claim 11, wherein:
the first AI model is an AI model corresponding to a first channel environment, and the second AI model is an AI model corresponding to a second channel environment;
wherein, a transmission rate corresponding to the first channel environment is different from a transmission rate corresponding to the second channel environment.

13. The method according to claim 11, wherein:
the first AI model is an AI model corresponding to a first AI processing capability, and the second AI model is an AI model corresponding to a second AI processing capability;
wherein, a delay corresponding to the first AI processing capability is different from a delay corresponding to the second AI processing capability.

14. The method according to claim 10, wherein:
the first CSI processing mode is an AI-based CSI processing mode corresponding to a first AI processing capability, and the second CSI processing mode is an AI-based CSI processing mode corresponding to a second AI processing capability;
wherein, a delay corresponding to the first AI processing capability is different from a delay corresponding to the second AI processing capability.

15. The method according to claim 10, wherein:
the first CSI processing mode is an AI-based CSI processing mode, and the second CSI processing mode is a non-AI-based CSI processing mode;
or,
the second CSI processing mode is an AI-based CSI processing mode, and the first CSI processing mode is a non-AI-based CSI processing mode other than the AI-based CSI processing mode.

16. The method according to claim 10, further comprising:
sending the CSI feedback information to the network device, wherein the CSI feedback information carries indication information of the second CSI processing mode used by the terminal.

17. A method for switching a channel status indicator (CSI) processing mode, being performed by a network device and comprising:
sending a switching instruction to a terminal, wherein the switching instruction is used to indicate the terminal to switch from a first CSI processing mode to a second CSI processing mode.

18.-21. (canceled)

22. The method according to claim 17, wherein:
the first CSI processing mode is an AI-based CSI processing mode, and the second CSI processing mode is a non-AI-based CSI processing mode;
or,
the second CSI processing mode is an AI-based CSI processing mode, and the first CSI processing mode is a non-AI-based CSI processing mode.

23. The method according to claim 17, wherein the switching instruction is a semi-static instruction or a dynamic instruction.

24. The method according to claim 17, wherein before sending the switching instruction to the terminal, the method further comprises:
receiving a switching request sent by the terminal, wherein the switching request is used to request switching of the CSI processing mode.

25. The method according to claim 17, wherein the switching instruction is carried in downlink control information (DCI).

26.-28. (canceled)

29. A terminal, comprising:
a processor; and
a transceiver connected with the processor,
wherein the processor is configured to load and execute executable instructions, thereby implementing the method for switching the CSI processing mode according to claim 1.

30. A network device, comprising:
a processor; and
a transceiver connected with the processor,
wherein the processor is configured to load and execute executable instructions, thereby implementing the method for switching the CSI processing mode according to claims 17.

31.-33. (canceled)

34. A terminal, comprising:
a processor; and
a transceiver connected with the processor,
wherein the processor is configured to load and execute executable instructions, thereby implementing the method for switching the CSI processing mode according to claim 10.
